(19) United States
(12) Patent Application Publication
(10) Pub. No.: US 2007/0046008 A1
(43) Pub. Date: Mar. 1, 2007

(54) Gas bag for a vehicle occupant restraint system

(75) Inventor: Markus Keutz, Rossdorf (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/510,380

(22) Filed: Aug. 24, 2006

(30) Foreign Application Priority Data
Aug. 26, 2005 (DE) 20 2005 013 509.7

(51) Int. Cl. B60R 21/231

(52) U.S. Cl. 280/743.1

(57) ABSTRACT

A gas bag for a vehicle occupant restraint system has a pre-cut section forming a lower part, and an upper part connected to the lower part. The pre-cut section forming the lower part, when spread out flat, is substantially one of trapezoidal and ring segment-shaped, and the lower part is funnel-shaped in the inflated state of the gas bag.

### FIELD OF THE INVENTION

The invention relates to a gas bag, in particular for a vehicle occupant restraint system.

### BACKGROUND OF THE INVENTION

Gas bags are still mainly produced by hand. A design which is as simple as possible therefore has a favourable effect upon the costs. For the protection of the driver, a gas bag is often made from two identical, round fabric layers which are sewn together along their circumference. However, these gas bags are not ideal, either with regard to the resulting shape or with regard to the flow of the filling gas. For example, in order to protect the gas bag wall from the hot gases, additional reinforcement layers must be fitted in the lower part, this making the gas bag heavier, more rigid and more expensive.

### BRIEF SUMMARY OF THE INVENTION

It is an object of the invention to optimise a gas bag.

To achieve this object, a gas bag for a vehicle occupant restraint system has a pre-cut section forming a lower part, and an upper part connected to the lower part. The pre-cut section forming the lower part, when spread out flat, is substantially one of trapezoidal and ring segment-shaped and the lower part is funnel-shaped in the inflated state of the gas bag. By changing the shape of the blank for the lower part in this way, with the same volume as a conventional gas bag, the depth of the gas bag can be increased, or with the same depth, the volume of the gas bag can be reduced. At the same time, due to the funnel-shape, the gas comes less into contact with the fabric of the lower part, and so the reinforcement layers can be reduced.

As with previous gas bags, the upper part and the lower part can be connected to one another all around along an outer circumferential line of the upper part.

Only one additional connection is required which connects the two inclined sides of the pre-cut section of the lower part to one another.

The lower part and the upper part each form a portion of an outer surface of the gas bag. Preferably, the outer surface of the gas bag is formed exclusively by the upper and the lower part.

In addition, on the narrow side of the pre-cut section of the lower part, several appendages can be arranged in order to attach the gas bag, e.g. in a housing of a gas bag module. These appendages can be formed in one part with the pre-cut section of the lower part. Preferably, the appendages extend toward the point of the funnel, and this results in particularly good force transmission into the gas bag fabric of the lower part.

Advantageously, the appendages have openings for attaching the gas bag in a gas bag module, by means of which separate attachment means can be totally or partially dispensed with. Of course, other attachment solutions can also be used.

A pre-cut section forming the upper part is preferably substantially circular or elliptical when spread out flat.

### BRIEF DESCRIPTION OF THE DRAWINGS

FIG. 1a shows a pre-cut section, spread out flat, forming the lower part of a gas bag according to the invention;

FIG. 1b shows a pre-cut section, spread out flat, forming the upper part of the gas bag according to the invention;

FIG. 2 shows the orientation of the fabric in the lower part;

FIG. 3 shows the gas bag according to the invention after a first sewing step;

FIG. 4 shows the gas bag from FIG. 3 after a second sewing step; and

FIG. 5 shows a schematic view of the gas bag according to the invention.

### DETAILED DESCRIPTION OF A PREFERRED EMBODIMENT

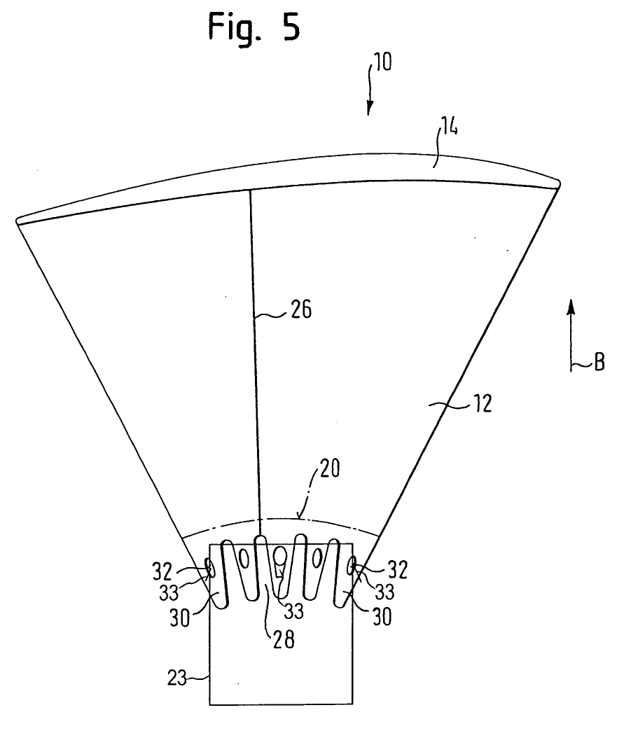

FIG. 5 shows a gas bag 10 in a completed, sewn-together state where it is spread out flat, but not inflated. The gas bag 10 has a lower part 12 and an upper part 14. Both lower part 12 and upper part 14 each form a portion of the outer surface of the gas bag 10, as can be seen from FIG. 5.

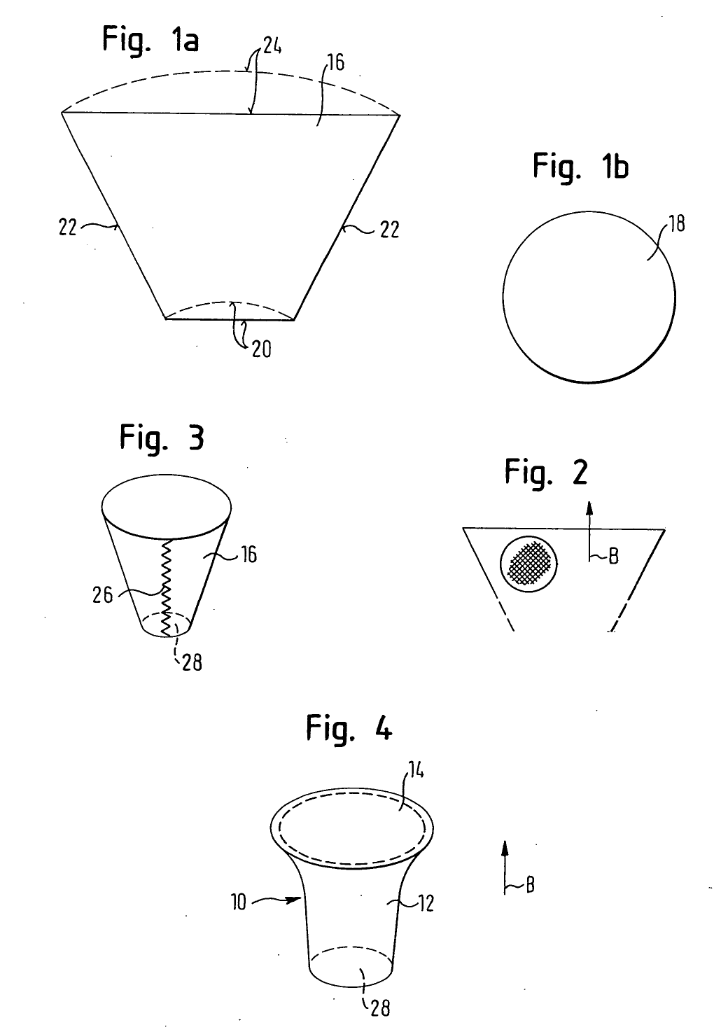

The pieces of fabric forming the respective pre-cut section 16,18 for the lower part 12 and the upper part 14 are shown spread out flat in FIGS. 1a and 1b. The pre-cut section 16 forming the lower part 12 is substantially trapezoid (continuous lines) or alternatively has a ring-segment shape (dashed lines). The pre-cut section 16 has a narrow side 20, two inclined sides 22 and a long side 24. When the cut-out section 16 is trapezoid, the narrow side 20 and the long side 24 extend in a straight line, and when the cut-out section 16 is ring segment-shaped, they are curved.

The pre-cut section 18 forming the upper part 14 is circular or elliptical.

The pre-cut section 16 forming the lower part 12 is oriented such that the run of the warp and weft threads of the gas bag fabric, as shown in FIG. 2, extends at an angle to the later direction of load B. The direction of load B coincides with the unfolding direction of the gas bag 10 from a module housing 23 (schematically in FIG. 5).

In order to produce the gas bag 10, the two inclined sides 22 of the pre-cut section 16 of the lower part 12 are first of all sewn together. In the example shown, a zigzag-shaped stretch stitch 26 is used for this so as to obtain more flexibility in the direction of load B. Other connection methods such as e.g. gluing or other forms of stitching can of course also be used.

Next, the pre-cut section 18, which forms the upper part 14, is sewn or connected in some other way along its circumference to the long side 24 of the pre-cut section 16. In the inflated state, the gas bag 10 now has the shape shown in FIG. 4. The lower part 12 forms a funnel, the point of which faces away from the upper part 14. At the point of the funnel, the gas bag 10 has an inflation opening 28. Gas released by a gas generator (not shown) flows through the inflation opening 28 into the inside of the gas bag 10.

On the edge of the inflation opening 28, the gas bag 10 is designed such that it can be connected to the module housing 23 of a gas bag module, e.g. a generator support. In FIG. 5, several, e.g. 12 in total, appendages 30 are shown which are formed in one piece with the lower part 12. In each appendage 30 an opening 32 is provided which can be pulled over an integrally moulded hook 33 or similar in a generator support or the module housing 23 (three hooks 33 are exemplarily shown in FIG. 5) so as to attach the gas bag 10.

In the gas bag 10 shown in FIG. 5, the narrow side 20 is formed by an imaginary, dot and dash line just above the appendages 30.

The appendages 30 all extend towards the point of the funnel, and elongating the funnel casing. The orientation and arrangement of all appendages 30 is thus ideal in order to receive forces occurring in the direction of load B.

The appendages 30 are produced e.g. by means of appropriate cutouts in the pre-cut section 16. They can, however, also be made from separate fabric parts and connected to the pre-cut section 16.

In addition, reinforcement layers (not shown) can be provided on the lower part 12. It is also possible to reinforce just the appendages 30.

Gas bags of this type can of course be used not just in the steering wheel, but also in other positions within the vehicle.

1. A gas bag for a vehicle occupant restraint system,
comprising: a pre-cut section (16) forming a lower part (12), and an upper part (14) connected to the lower part (12),
wherein the pre-cut section (16) forming the lower part (12), when spread out flat, is substantially one of trapezoidal and ring segment-shaped and wherein the lower part (12) is funnel-shaped in the inflated state of the gas bag (10).

2. The gas bag according to claim 1, wherein the upper part (14) and the lower part (12) are connected to one another all around along an outer circumferential line of the upper part (14).

3. The gas bag according to claim 1, wherein the two inclined sides (22) of the pre-cut section (16) of the lower part (12) are connected to one another.

4. The gas bag according to claim 1, wherein on the narrow side (20) of the pre-cut section (16) of the lower part (12) several appendages (30) are arranged in order to attach the gas bag (10).

5. The gas bag according to claim 4, wherein the appendages (30) are formed in one part with the pre-cut section (16) of the lower part (12).

6. The gas bag according to claim 4, wherein the appendages (30) extend toward the point of the funnel.

7. The gas bag according to claim 4, wherein the appendages (30) have openings (32) for attaching the gas bag (10) in a gas bag module.

8. The gas bag according to claim 1, wherein a pre-cut section (18) forming the upper part (14) is substantially one of circular or elliptical when spread out flat.

9. The gas bag according to claim 1, wherein the lower part (12) and the upper part (14) form portions of an outer surface of the gas bag (10).
